(19) United States
(12) Patent Application Publication
(10) Pub. No.: US 2016/0258345 A1
(43) Pub. Date: Sep. 8, 2016

(54) INTERNAL COMBUSTION ENGINE

(71) Applicant: TOYOTA JIDOSHA KABUSHIKI KAISHA, Toyota-shi (JP)

(72) Inventor: Koshiro KIMURA, Susono-shi (JP)

(73) Assignee: TOYOTA JIDOSHA KABUSHIKI KAISHA, Toyota-shi (JP)

(21) Appl. No.: 14/989,127

(22) Filed: Jan. 6, 2016

(30) Foreign Application Priority Data
Mar. 6, 2015 (JP) 2015-045052

(51) Int. Cl. F02B 23/10; F02D 41/30

(52) U.S. Cl. CPC F02B 23/10; F02D 41/3094; F02B 2023/108

(57) ABSTRACT

An internal combustion engine where a tumble flow is generated inside a combustion chamber includes: a spark plug; an in-cylinder injection valve that injects fuel at a specific timing so that a fuel spray proceeds towards the vortex center of the tumble flow at the time of stratified charge combustion operation; and a control device that, in a case where the size of a combustion fluctuation during the stratified charge combustion operation is greater than a determination value, changes an in-cylinder injection ratio so that a plug-periphery air-fuel ratio becomes richer. The changing of the ratio is performed by, first, decreasing the ratio by a fixed amount, and when the plug-periphery air-fuel ratio becomes richer as a result thereof, continuing to decrease the ratio, while when the aforementioned result is that the plug-periphery air-fuel ratio becomes leaner, increasing the ratio.

### BACKGROUND

1. Technical Field

Preferred embodiments relate to an internal combustion engine, and more particularly to an internal combustion engine in which stratified charge combustion operation is performed utilizing a tumble flow.

2. Background Art

A control device for an in-cylinder direct injection engine that performs stratified charge combustion operation is disclosed in Japanese Patent Laid-Open No. 2002-276421. In order to perform stratified charge combustion operation by retaining a combustible air-fuel mixture at the periphery of a spark plug at the spark timing, the aforementioned control device is configured to inject fuel towards a tumble flow that flows towards the fuel injection valve so that the fuel moves in a direction that is counter to the direction of the tumble flow. In addition, to achieve a balance between the strength of the tumble flow and a spray penetration force of the fuel and thereby realize stable stratified charge combustion, the control device adjusts the spray penetration force by controlling the fuel injection pressure. More specifically, at a time of idling operation, while gradually changing the fuel injection pressure within a total range from a set lower limit value to a set upper limit value, processing is performed that corrects the fuel injection timing so that the size of a combustion fluctuation within the aforementioned total range becomes equal to or less than a predetermined value.

### LIST OF RELATED ART

Following is a list of patent documents which the applicant has noticed as related arts of the present application.

### [Patent Document 1]

Japanese Patent Laid-Open No. 2002-276421

### [Patent Document 2]

Japanese Patent Laid-Open No. 2005-325825

### [Patent Document 3]

Japanese Patent Laid-Open No. 2005-083277

### Technical Problem

The strength of a tumble flow (tumble ratio) may change over time due to reasons such as the accumulation of deposits at an intake port. The spray penetration force of fuel also can change over time due to reasons such as the accumulation of deposits at, for example, an injection hole of a fuel injection valve. Consequently, when a configuration is adopted that guides a fuel spray to the periphery of a spark plug utilizing a tumble flow to achieve stratified charge combustion, if the strength of the tumble flow or the spray penetration force changes over time, there is a concern that an unbalance will arise between the strength of the tumble flow and the spray penetration force. If such an unbalance arises, the degree of stratification of the combustible air-fuel mixture at the periphery of the spark plug will decrease at the spark timing. If the degree of stratification decreases, that is, if the air-fuel ratio of the aforementioned air-fuel mixture becomes leaner, combustion fluctuations will increase and torque fluctuations will increase.

According to the technique disclosed in Japanese Patent Laid-Open No. 2002-276421, to eliminate an unbalance between the strength of the tumble flow and the spray penetration force, it is necessary to perform an operation that changes the fuel injection pressure in its total range from a set lower limit value to a set upper limit value. However, there is a concern that exhaust emissions and the like will be adversely affected if a parameter associated with combustion, such as the fuel injection pressure, is casually changed by a large amount. For example, in the case of the fuel injection pressure used in the technique described in Japanese Patent Laid-Open No. 2002-276421, although the spray penetration force can be reduced by lowering the fuel injection pressure, atomization of fuel will be hindered as a result. Consequently, a problem such as an increase in the amount of fuel that adheres to an in-cylinder wall surface or an increase in carbon monoxide (CO) may arise.

Thus, it can be said that in order to restore the degree of stratification of a combustible air-fuel mixture at the periphery of a spark plug at the spark timing by reducing the above-described unbalance, it is important not to change, as much as possible, a parameter associated with combustion. The technique disclosed in Japanese Patent Laid-Open No. 2002-276421 is premised on changing the fuel injection pressure throughout the whole of a predefined range, namely, a total range from a set lower limit value to a set upper limit value, without the use of an indicator for efficiently changing the fuel injection pressure (that is, the spray penetration force) from the viewpoint of restoring the degree of stratification. In this respect, room for improvement still remains in the technique disclosed in Japanese Patent Laid-Open No. 2002-276421 with regard to use of the technique for improving the balance between the strength of a tumble flow and a spray penetration force.

### SUMMARY

Preferred embodiments address the above-described problem and have an object to provide an internal combustion engine that is configured to improve the balance between the strength of a tumble flow and a spray penetration force that deteriorates due to a change over time, while efficiently changing the spray penetration force from the viewpoint of restoring the degree of stratification of a combustible air-fuel mixture at the periphery of a spark plug at the spark timing.

An internal combustion engine according to preferred embodiments, in which a tumble flow is generated inside a combustion chamber, includes a spark plug, an in-cylinder injection valve and a control device. The spark plug is arranged at a central part of a wall surface of the combustion chamber on a cylinder head side. The in-cylinder injection valve is configured to inject fuel at a specific timing so that, when stratified charge combustion operation is performed, a fuel spray proceeds towards a vortex center of the tumble flow. The control device is configured to calculate a size of a combustion fluctuation during stratified charge combustion operation, and in a case where the size of the combustion fluctuation that is calculated is greater than a determination value, change a spray penetration force of fuel injection that is performed at the specific timing so that a plug-periphery air-fuel ratio that is an air-fuel ratio of an air-fuel mixture at a periphery of the spark plug at an spark timing changes to a rich side. The control device is further configured to calculate an air-fuel ratio index value that has a correlation with the plug-periphery air-fuel ratio. Changing of the spray penetration force by the control device is performed by performing any one operation among an operation that increases the spray penetration force and an operation that decreases the spray penetration force, and in a case where the air-fuel ratio index value exhibits a change to a rich side as a result of performing the one operation a first time, the one operation is continued, while in a case where the air-fuel ratio index value exhibits a change to a lean side as a result of performing the one operation the first time, the other operation among the operation that increases the spray penetration force and the operation that decreases the spray penetration force is performed.

The control device may continue performance of the one operation or the other operation until the air-fuel ratio index value stops exhibiting a change to the rich side.

The internal combustion engine may perform, during a single cycle, fuel injection a plurality of times including fuel injection at the specific timing. Also, the changing of the spray penetration force by the control device may be performed by changing a fuel injection ratio that is a ratio of an amount of fuel injected by the fuel injection at the specific timing with respect to a total amount of fuel injected by the fuel injection that is performed the plurality of times.

The internal combustion engine may include a port injection valve configured to inject fuel into an intake port. The total fuel injection amount may be a total value of fuel injection amounts by fuel injection that is performed the plurality of times using the in-cylinder injection valve and the port injection valve during a single cycle.

The internal combustion engine may include an in-cylinder pressure sensor that detects an in-cylinder pressure. The control device may calculate a heat release rate inside a cylinder based on an in-cylinder pressure that is detected by the in-cylinder pressure sensor. Also, the air-fuel ratio index value may be a size of a heat release rate inside the cylinder at a predetermined crank angle timing.

According to the internal combustion engine of preferred embodiments, in a case where the size of a combustion fluctuation during stratified charge combustion operation is greater than a determination value, the spray penetration force of fuel injection that is performed at a specific timing for stratification is changed so that the plug-periphery air-fuel ratio changes to the rich side. This change in the spray penetration force is performed as follows. That is, first, any one operation among an operation that increases the spray penetration force and an operation that decreases the spray penetration force is performed, and in accordance with whether the plug-periphery air-fuel ratio changes to the rich side or changes to the lean side as a result of performing the one operation a first time, the direction in which to change the spray penetration force from a second time onwards is determined. More specifically, in a case where an air-fuel ratio index value that has a correlation with a plug-periphery air-fuel ratio exhibits a change to the rich side as a result of performing one of the operations a first time, the aforementioned one operation among the operation that increases the spray penetration force and the operation that decreases the spray penetration force is continued, while in a case where the air-fuel ratio index value exhibits a change to the lean side as a result of performing one of the operations a first time, the other operation among the operation that increases the spray penetration force and the operation that decreases the spray penetration force is performed. According to this technique, the direction in which the spray penetration force should be changed can be appropriately determined by taking into consideration a pattern of a change over time that is a factor that increases combustion fluctuations. Therefore, according to the internal combustion engine of preferred embodiments, a balance between the strength of a tumble flow and a spray penetration force that deteriorates due to a change over time is improved while efficiently changing the spray penetration force from the viewpoint of restoring the degree of stratification of a combustible air-fuel mixture at the periphery of a spark plug at the spark timing.

### BRIEF DESCRIPTION OF THE DRAWINGS

FIG. 1 is a schematic diagram for describing the system configuration of an internal combustion engine according to a first embodiment of the present invention;

FIG. 2 is a view for describing a decrease in the degree of stratification of a plug-periphery air-fuel mixture that is caused by a change over time;

FIG. 3 is a view for describing a change over time in an optimal injection ratio Rb of an in-cylinder injection valve;

FIG. 4 is a view for describing a characteristic restoration operation with respect to the degree of stratification of the plug-periphery air-fuel mixture according to the first embodiment of the present invention, which is performed in a case where a change over time has arisen in the internal combustion engine;

FIG. 5 is a view for describing the effect of the restoration operation for the degree of stratification of the plug-periphery air-fuel mixture that is described above referring to FIG. 4;

FIG. 6 is a flowchart illustrating the flow of control according to the first embodiment of the present invention;

FIG. 7 is a view for describing one example of a technique for calculating the plug-periphery air-fuel ratio, and shows the relation between a heat release rate dQ/dθ and a crank angle;

FIG. 8 is a view illustrating the relation between the heat release rate dQ/dθ at a determination timing and the plug-periphery air-fuel ratio;

FIG. 9 is a view for describing a characteristic restoration operation to restore the degree of stratification of a plug-periphery air-fuel mixture according to a second embodiment of the present invention, which is performed in a case where a change over time occurs in the internal combustion engine;

FIG. 10 is a flowchart illustrating the flow of control according to the second embodiment of the present invention; and

FIG. 11 is a view that illustrates the manner in which a reverse tumble flow that descends on the intake side and ascends on the exhaust side is generated inside the combustion chamber.

### DETAILED DESCRIPTION

### First Embodiment

### Configuration of First Embodiment

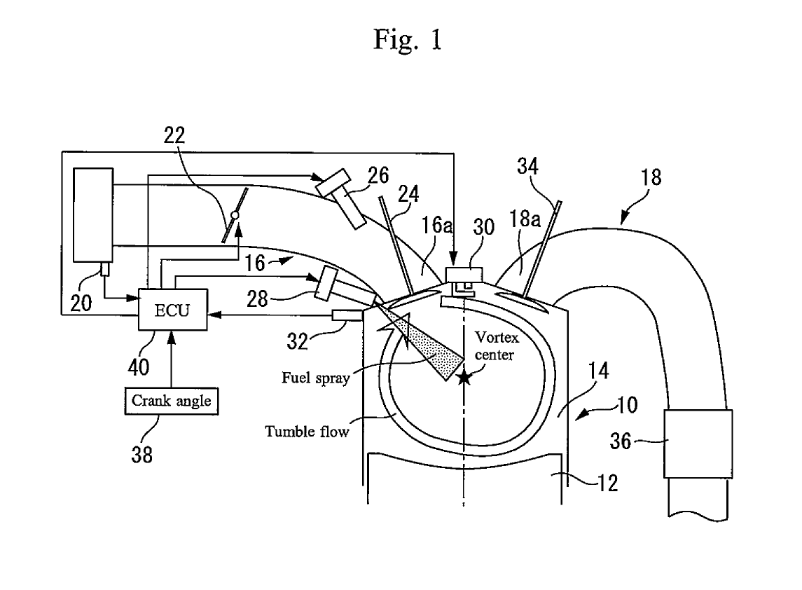

FIG. 1 is a schematic diagram for describing the system configuration of an internal combustion engine 10 according to a first embodiment of the present invention. The system of the present embodiment includes the spark-ignition-type internal combustion engine 10. A piston 12 is provided in each cylinder of the internal combustion engine 10. A combustion chamber 14 is formed on the top side of the piston 12 inside the cylinder. An intake passage 16 and an exhaust passage 18 communicate with the combustion chamber 14.

An air flow meter 20 for measuring an intake air flow rate is arranged in the vicinity of the inlet of the intake passage 16. An electronically controlled throttle valve 22 is also provided in the intake passage 16. The throttle valve 22 can adjust an intake air flow rate by the opening degree of the throttle valve 22 being adjusted in accordance with an accelerator position.

An intake port 16a that is a site in the intake passage 16 at which the intake passage 16 is connected to the combustion chamber 14 is formed so as to generate a vertically rotating vortex, that is, a tumble flow, inside the combustion chamber 14 by the flow of intake air. Note that, generation of a tumble flow is not limited to generation of a tumble flow that is caused by selecting the shape of the intake port 16a as described above. That is, for example, a configuration may also be adopted in which a tumble control valve (TCV) that makes the strength of a tumble flow (tumble ratio) variable is provided in the intake passage, and in which a tumble flow is generated by controlling the opening degree of the TCV.

Intake valves 24, each of which opens and closes the intake port 16a, are provided in the intake port 16a. A port injection valve 26 that injects fuel into the intake port 16a, and an in-cylinder injection valve 28 that directly injects fuel into the combustion chamber 14 are provided in each cylinder of the internal combustion engine 10. A spark plug 30 of an ignition device (not illustrated in the drawings) for igniting an air-fuel mixture is also provided in each cylinder. The spark plug 30 is arranged at a central part of a wall surface of the combustion chamber 14 on the cylinder head side. In addition, an in-cylinder pressure sensor 32 that detects an in-cylinder pressure is provided in each cylinder.

An exhaust port 18a of the exhaust passage 18 is provided with exhaust valves 34, each of which opens and closes the exhaust port 18a. An exhaust gas purification catalyst 36 for purifying exhaust gas is also disposed in the exhaust passage 18. In addition, a crank angle sensor 38 for detecting a crank angle and an engine speed is installed in the vicinity of a crankshaft (not illustrated in the drawings) of the internal combustion engine 10.

The system illustrated in FIG. 1 also includes an electronic control unit (ECU) 40. The ECU 40 includes an input/output interface, a memory, and a central processing unit (CPU). The input/output interface is configured to take in sensor signals from various sensors installed in the internal combustion engine 10 or the vehicle in which the internal combustion engine 10 is mounted, and to also output actuating signals to various actuators for controlling the internal combustion engine 10. Various control programs and maps and the like for controlling the internal combustion engine 10 are stored in the memory. The CPU reads out a control program or the like from the memory and executes the control program or the like, and generates actuating signals for the various actuators based on sensor signals taken in. The sensors from which the ECU 40 takes in signals include various sensors for acquiring the engine operating state, such as the aforementioned air flow meter 20, in-cylinder pressure sensor 32 and crank angle sensor 38. The actuators to which the ECU 40 outputs actuating signals include the aforementioned throttle valve 22, port injection valve 26 and in-cylinder injection valve 28 as well as the aforementioned ignition device.

### (Stratified Charge Combustion Utilizing Tumble Flow)

As described above, by prior selection of the shape of the intake port 16a, the internal combustion engine 10 is configured so that a tumble flow is generated inside the combustion chamber 14. More specifically, the tumble flow that is generated in the present embodiment is, as illustrated in FIG. 1, a forward tumble flow that ascends on the intake side and descends on the exhaust side.

In the present embodiment, in order to realize stratified charge combustion, an air guide method that utilizes the aforementioned tumble flow, that is, a method that transports a fuel spray to the periphery of the spark plug 30 by means of the tumble flow is used. The term “stratified charge combustion” refers to combustion that is performed by forming, in the vicinity of the first spark plug 30 at the spark timing, an air-fuel mixture layer for which the air-fuel ratio is richer than that on the outside thereof. Note that FIG. 1 illustrates a state in the vicinity of 90° C.A before compression top dead center (compression TDC).

To enable the performance of stratified charge combustion using the air guide method, the injection angle of the in-cylinder injection valve 28 is set so that the in-cylinder injection valve 28 can inject fuel towards the vortex center of the tumble flow at a specific timing T in a middle period of the compression stroke. The term “middle period of the compression stroke” used here is preferably 120 to 60° C.A before compression TDC. As one example, the specific timing T here is taken as 90° C.A before compression TDC.

As a technique for injecting fuel when performing stratified charge combustion, according to the present embodiment a technique is used that divides a fuel injection amount that should be injected during a single cycle into a plurality of fuel injection amounts, and uses the port injection valve 26 and the in-cylinder injection valve 28 in a shared manner as fuel injection valves for performing injection of the individual fuel injection amounts after dividing up the fuel injection amount. More specifically, a first fuel injection is performed using the port injection valve 26 and a second fuel injection is performed using the in-cylinder injection valve 28. The first fuel injection is the main fuel injection, and the main part of the amount of fuel that should be injected during a single cycle is injected by the port injection valve 26 in the exhaust stroke or the intake stroke. The second fuel injection is injection of the remaining part of the amount of fuel that should be injected during a single cycle, and is injection of a small amount of fuel that is required for stratification. The second fuel injection is performed by means of the in-cylinder injection valve 28 at the aforementioned specific timing T (90° C.A before compression TDC).

By performing the aforementioned second fuel injection with an appropriate spray penetration force with respect to the strength of the tumble flow, the fuel spray proceeds towards the vortex center of the tumble flow, and as a result the fuel spray becomes wrapped by the tumble flow. The fuel spray that is wrapped by the tumble flow is carried to the periphery of the spark plug 30 accompanying ascent of the piston 12. By this means, gas inside the cylinder can be stratified so that an air-fuel mixture layer that is at the periphery of the spark plug 30 at the spark timing becomes a combustible air-fuel mixture layer for which the air-fuel ratio is richer than that on the outside thereof.

### Control of First Embodiment

### Operating Conditions Subject for Control of the Present Embodiment

The control of the present embodiment that is described hereunder is performed taking fast idle operation as the object thereof. Fast idle operation is performed immediately after a cold start-up of the internal combustion engine 10 in order to maintain the idle rotational speed at a higher speed than the normal idle rotational speed that is used after warming up ends.

### (Advantages of Performing Stratified Charge Combustion at Time of Fast Idle Operation)

In the present embodiment, stratified charge combustion is performed utilizing the aforementioned air guide method at a time of fast idle operation. If stratified charge combustion is performed at a time of fast idling, a combustible air-fuel mixture layer having a higher fuel concentration than that on the outside thereof can be generated at the periphery of the spark plug 30 without significantly enriching the overall air-fuel ratio in the cylinder. Hence, combustion after a cold start-up can be stabilized while reducing fuel consumption.

Further, realization of favorable stratified charge combustion is also effective from the viewpoint of suppressing the discharge of nitrogen oxides (NOx). That is, the generated amount of NOx within a cylinder increases when the air-fuel ratio of the air-fuel mixture that is subjected to combustion is in the vicinity of 16. Raising the degree of stratification of the air-fuel mixture means that the air-fuel ratio of the air-fuel mixture layer at the periphery of the spark plug 30 is enriched. Accordingly, by favorably raising the degree of stratification of the air-fuel mixture at the periphery of the spark plug 30 at the spark timing, formation of an air-fuel mixture layer for which the air-fuel ratio is a value in the vicinity of 16 can be suppressed at the periphery of the spark plug 30 at the spark timing, and thus the generation of NOx can be suppressed. Hereunder, in the present description, to facilitate description of the application, an air-fuel mixture at the periphery of the spark plug 30 around the spark timing is referred to as “plug-periphery air-fuel mixture”, and the air-fuel ratio of the plug-periphery air-fuel mixture is referred to as “plug-periphery air-fuel ratio”.

Further, in the present embodiment, retardation of the spark timing is performed to suppress the discharge of hydrocarbon (HC) and promote warming up of the exhaust gas purification catalyst 36 at the time of fast idle operation. The spark timing retardation control is control that retards the spark timing by a large amount from the optimal spark timing (MBT (minimum spark advance for best torque) spark timing). More specifically, for example, the spark timing is retarded so as to be a timing that is after the compression TDC. By retarding the spark timing by a large amount in this manner and performing combustion, it is possible to promote afterburning of HC in the exhaust passage 18, and also increase the exhaust gas temperature to promote warming up of the exhaust gas purification catalyst 36. In addition, when the spark timing is retarded, ignition generally becomes unstable. However, raising the degree of stratification of the plug-periphery air-fuel mixture also has the effect of stabilizing ignition in a case where this kind of spark timing retardation control is being performed.

### (Issues Related to Stratified Charge Combustion Utilizing Air Guide Method)

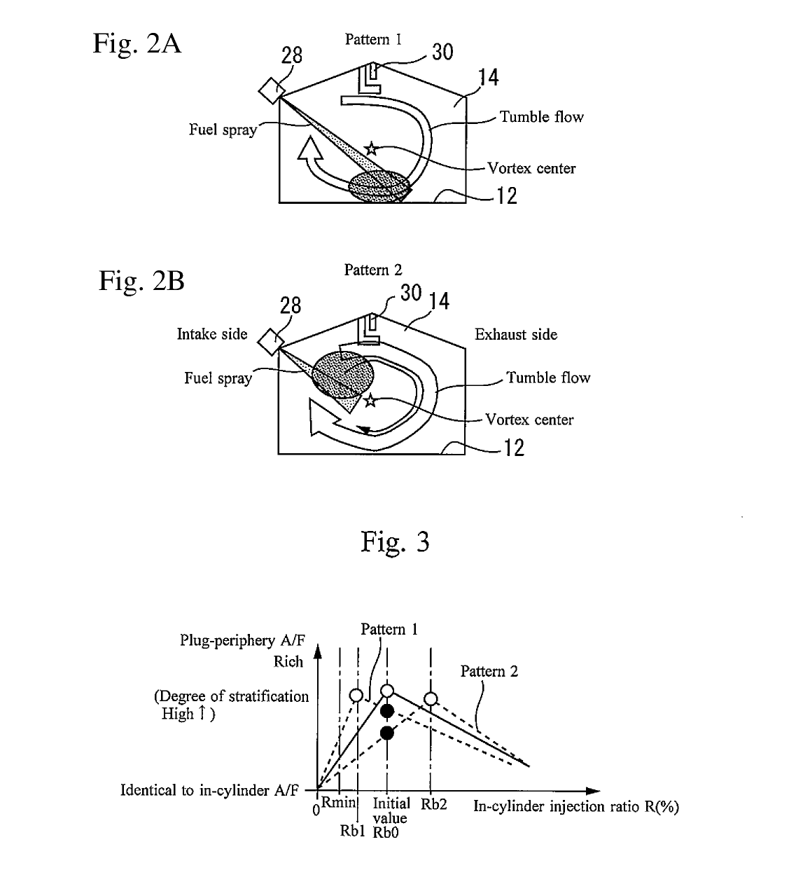

FIG. 2 is a view for describing a decrease in the degree of stratification of the plug-periphery air-fuel mixture that is caused by a change over time. Note that, FIG. 2 illustrates a state inside a cylinder at a central cross-section that passes through an axis line of the cylinder. The degree of stratification of the plug-periphery air-fuel mixture may sometimes decrease as a result of a change over time in the internal combustion engine 10. As shown in FIG. 2, a pattern 1 and a pattern 2 may be considered as patterns of such a decrease in the degree of stratification.

The aforementioned air guide method is a method whereby fuel injection is performed so that the fuel spray proceeds towards the vortex center of the tumble flow, and the fuel spray is carried to the periphery of the spark plug 30 in a state in which the fuel spray is wrapped by the tumble flow. In order to enable such an operation AG to be appropriately realized, a configuration is adopted so that the fuel injection at the specific timing T by the in-cylinder injection valve 28 is performed with an appropriate spray penetration force with respect to the strength of the tumble flow that is generated inside the cylinder.

Adjustment of the spray penetration force can be performed by changing a fuel injection ratio. The term “fuel injection ratio” used here refers to a ratio of an amount of fuel for which fuel injection is performed at the specific timing T with respect to the total fuel injection amount that is the total amount of fuel to be injected during a single cycle. In the internal combustion engine 10 of the present embodiment, the total value of the amounts of fuel injected by fuel injection operations performed using the port injection valve 26 and the in-cylinder injection valve 28 during a single cycle corresponds to the aforementioned total fuel injection amount. The ratio of the amount of fuel that is injected at the specific timing T with respect to the total fuel injection amount corresponds to the aforementioned fuel injection ratio (hereunder, referred to as “in-cylinder injection ratio R”).

The spray penetration force increases as the amount of fuel injection at the specific timing T increases. An in-cylinder injection ratio R that can make the balance between the strength of the tumble flow and the spray penetration force an appropriate balance that is required to realize the above-described operation AG is stored as an initial value (adaptive value) Rb0 in the ECU 40. If the balance between the strength of the tumble flow and the spray penetration force is the optimal balance with regard to realizing the above-described operation AG, the degree of stratification of the plug-periphery air-fuel mixture can be increased most, and as a result it is possible to favorably enrich the plug-periphery air-fuel ratio.

Here, the spray penetration force and the strength of the tumble flow (tumble ratio) can both change as a result of a change over time. More specifically, with respect to the spray penetration force, for example, the spray penetration force may sometimes become greater than an initial target value (that is, a value corresponding to the initial value Rb0) due to accumulation of deposits at an injection hole of the in-cylinder injection valve 28. On the other hand, with regard to the strength of the tumble flow, for example, the tumble ratio may sometimes become higher than an initial target value (similarly, a value corresponding to the initial value Rb0) due to the flow path area of the intake port 16a decreasing as a result of accumulation of deposits at the intake port 16a. In a case where the spray penetration force or the tumble ratio changes over time with respect to the initial target value due to such reasons, the appropriate balance between the strength of the tumble flow and the spray penetration force that is obtained by a combination of the respective initial target values may be lost as in the manner of the following pattern 1 or 2. As a result, the degree of stratification of the plug-periphery air-fuel mixture decreases.

Pattern 1 corresponds to a case where, as a result of an increase over time in the spray penetration force, the spray penetration force becomes too large relative to the strength of the tumble flow. In this case, as shown in FIG. 2, after the fuel spray passes through the vortex center of the tumble flow, the fuel spray rides on the tumble flow and diffuses. As a result, the degree of stratification decreases.

Pattern 2 corresponds to a case where, as a result of an increase over time in the strength of the tumble flow, the strength of the tumble flow becomes too large relative to the spray penetration force. In this case, as shown in FIG. 2, the fuel spray does not reach the vortex center, and instead rides on the tumble flow and diffuses. As a result, the degree of stratification decreases also in this case.

FIG. 3 is a view for describing a change over time in an optimal injection ratio Rb of the in-cylinder injection valve 28. FIG. 3 illustrates the relation between the plug-periphery air-fuel ratio and the in-cylinder injection ratio R. As described above, the spray penetration force increases as the amount of fuel injected at the specific timing T increases (that is, as the in-cylinder injection ratio R increases).

A solid line shown in FIG. 3 indicates a characteristic when the internal combustion engine 10 is in an initial state in which a change over time has not occurred. When the in-cylinder injection ratio R is zero, the air-fuel mixture in the cylinder is not stratified, and hence the plug-periphery air-fuel ratio is equal to the air-fuel ratio in the cylinder (that is, a supply air-fuel ratio that is defined by the intake air amount and the fuel injection amount). A “minimum injection ratio Rmin” shown in FIG. 3 is the in-cylinder injection ratio R at a time when the fuel injection amount of the in-cylinder injection valve 28 is a minimum injection amount. The term “minimum injection amount” refers to a value that corresponds to a lower limit value within the control range of the fuel injection amount of the in-cylinder injection valve 28 that is controlled by the ECU 40.

The spray penetration force increases as the in-cylinder injection ratio R increases from the minimum injection ratio Rmin. As a result, accompanying an increase in the in-cylinder injection ratio R, the degree of stratification of the plug-periphery air-fuel mixture increases and the plug-periphery air-fuel ratio is enriched. At a time that the balance between the strength of the tumble flow and the spray penetration force becomes the optimal balance accompanying an increase in the in-cylinder injection ratio R, the fuel spray can be optimally wrapped by the tumble flow. Consequently, the degree of stratification becomes highest at this time, and the plug-periphery air-fuel ratio becomes richest. The in-cylinder injection ratio R at this time is the “optimal injection ratio Rb”. More specifically, the aforementioned initial value Rb0 of the in-cylinder injection ratio R stored in the ECU 40 corresponds to the optimal injection ratio Rb at a time that the strength of the tumble flow is the aforementioned initial target value (design target value), and the spray penetration force of the fuel injection at the optimal injection ratio Rb0 corresponds to the aforementioned initial target value.

If the in-cylinder injection ratio R is increased relative to the optimal injection ratio Rb0 with respect to the solid line shown in FIG. 3, the spray penetration force will increase to exceed the optimal balance and hence the degree of stratification will decrease for a similar reason as in the case of pattern 1 shown in FIG. 2.

The optimal injection ratio Rb of the in-cylinder injection ratio R described above changes due to a change over time in the internal combustion engine 10 (the above-described change over time in pattern 1 or pattern 2). Specifically, since pattern 1 represents a case where the spray penetration force becomes too large, as shown in FIG. 3, the optimal injection ratio Rb1 under circumstances in which a change over time of pattern 1 is occurring changes to a low in-cylinder injection ratio side relative to the initial value Rb0. On the other hand, since pattern 2 represents a case where the strength of the tumble flow becomes too large, the optimal injection ratio Rb2 under circumstances in which a change over time of pattern 2 is occurring changes to a high in-cylinder injection ratio side relative to the initial value Rb0.

Accordingly, if the in-cylinder injection ratio R remains at the initial value Rb0 regardless of the fact that a change over time of pattern 1 or pattern 2 is occurring, as indicated by a black circular mark in FIG. 3, the degree of stratification will decrease in comparison to a time that the optimal injection ratio Rb1 or Rb2 under circumstances in which the current change over time is occurring is used. If the degree of stratification decreases, the plug-periphery air-fuel ratio becomes leaner. As a result, the rate of combustion slows down, and hence the combustion becomes unstable. Torque fluctuations increase when the combustion becomes unstable. Further, the discharged amount of NOx increases due to a decrease in the degree of stratification.

As described above, if the degree of stratification of the plug-periphery air-fuel mixture decreases due to a change over time, torque fluctuations increase accompanying an increase in the combustion fluctuations, and the discharged amount of NOx also increases. Therefore, in the present embodiment, in a case where the degree of stratification has decreased due to a change over time, a countermeasure is implemented whereby the spray penetration force is changed so as to appropriately restore the degree of stratification. More specifically, the in-cylinder injection ratio R is changed so that the optimal injection ratio Rb under the current state in which a change over time is occurring is obtained.

It is possible to estimate whether or not the degree of stratification of the plug-periphery air-fuel mixture has decreased during stratified charge combustion operation, based on the size of a combustion fluctuation. However, in a case where a change over time has arisen, it is not possible to determine whether the pattern of the change over time is pattern 1 or pattern 2 merely by determining the size of the combustion fluctuation. Accordingly, if the spray penetration force is changed without an appropriate indicator, it will be difficult to efficiently restore the degree of stratification. For example, when the size of combustion fluctuation exceeds a certain determination value, in a case where a countermeasure is implemented whereby, without focusing attention on distinguishing the pattern of the change over time, the spray penetration force is decreased in one direction until a predetermined limit value and thereafter the spray penetration force is increased as far as a predetermined limit value, the following problem arises. That is, according to this countermeasure, in a case where a change over time of pattern 1 is occurring, that is, a case where the spray penetration force is increasing, it can be said that the balance between the strength of the tumble flow and the spray penetration force can be improved by decreasing the spray penetration force, and thus the degree of stratification can be improved (restored). However, in a case where a change over time of pattern 2 is occurring, that is, a case where the tumble flow is becoming stronger, if the aforementioned countermeasure is implemented, the unbalance between the strength of the tumble flow and the spray penetration force will, on the contrary, increase in the course of the operation to restore the degree of stratification.

### Characteristic Operation in First Embodiment

FIG. 4 is a view for describing a characteristic restoration operation with respect to the degree of stratification of the plug-periphery air-fuel mixture according to the first embodiment of the present invention, which is performed in a case where a change over time has arisen in the internal combustion engine 10. In the present embodiment, in a case where a change over time arose, the following operations are performed to change the spray penetration force so as that the degree of stratification of the plug-periphery air-fuel mixture is efficiently restored while solving the above described problem. That is, accompanying processing for determining which pattern among pattern 1 and 2 corresponds to the pattern of the change over time, an operation is performed to search for the optimal injection ratio Rb of the in-cylinder injection ratio R.

As described above, it is possible to determine whether or not a decrease in the degree of stratification that is due to a change over time has arisen, based on whether or not the size of a combustion fluctuation exceeds a certain determination value. The in-cylinder injection ratio R at the time point at which the size of the combustion fluctuation exceeds the determination value is, as shown in FIG. 4, the initial value Rb0. In the present embodiment, an initial change in the in-cylinder injection ratio R for changing the spray penetration force is performed by lowering the in-cylinder injection ratio R on a trial basis by only a predetermined fixed amount X.

In a case where the pattern of the change over time that is occurring is pattern 1, if the spray penetration force is reduced by the aforementioned change in the in-cylinder injection ratio R, the balance between the strength of the tumble flow and the spray penetration force improves. As a result, the degree of stratification increases and the plug-periphery air-fuel ratio becomes richer. Therefore, in a case where the plug-periphery air-fuel ratio becomes richer as a result of lowering the in-cylinder injection ratio R by the fixed amount X the first time, it can be determined that the pattern of the current change over time is pattern 1. If the situation is one in which a change over time of pattern 1 is occurring, during a period until the in-cylinder injection ratio R becomes the optimal injection ratio Rb1 under this situation, the plug-periphery air-fuel ratio becomes richer by lowering the in-cylinder injection ratio R.

Therefore, in this case, as shown by the solid line in FIG. 4, an operation to gradually lower the in-cylinder injection ratio R by an amount corresponding to the fixed amount X each time is continued until the plug-periphery air-fuel ratio stops exhibiting a change to the rich side. The in-cylinder injection ratio R at the time that the plug-periphery air-fuel ratio becomes richest as a result of this operation is regarded as the optimal injection ratio Rb1 under circumstances in which a change over time of pattern 1 is occurring. Further, in a stratified charge combustion operation performed thereafter, this optimal injection ratio Rb1 is used as the in-cylinder injection ratio R in which the influence of the current change over time has been reflected. Note that, in a case where the in-cylinder injection ratio R arrives at the minimum injection ratio Rmin during the course of the operation to change the in-cylinder injection ratio R, the minimum injection ratio Rmin is used as the in-cylinder injection ratio R in which the influence of the current change over time has been reflected.

On the other hand, in a case where the pattern of the change over time that is occurring is pattern 2, if the spray penetration force is reduced by the aforementioned change in the in-cylinder injection ratio R, the balance between the strength of the tumble flow and the spray penetration force deteriorates. As a result, the degree of stratification decreases and the plug-periphery air-fuel ratio becomes leaner. Therefore, in a case where the plug-periphery air-fuel ratio becomes leaner as a result of lowering the in-cylinder injection ratio R by the fixed amount X the first time, it can be determined that the pattern of the current change over time is pattern 2. If the operation to lower the in-cylinder injection ratio R is continued regardless of the fact that the operation is performed under such circumstances, the degree of stratification will decrease further, and the plug-periphery air-fuel ratio will become leaner.

Therefore, in this case, as shown by the broken line in FIG. 4, changing of the in-cylinder injection ratio R that is performed the second time is performed in an opposite direction to the operation that is performed the first time (that is, a direction that increases the in-cylinder injection ratio R). The amount by which the in-cylinder injection ratio R is changed in this case is also the fixed amount X. However, the change amount need not necessarily be the same fixed amount X. During a period until the in-cylinder injection ratio R becomes the optimal injection ratio Rb2 under circumstances in which the change over time of pattern 2 is occurring, the plug-periphery air-fuel ratio becomes richer as a result of raising the in-cylinder injection ratio R. Consequently, in this case, as illustrated by the broken line in FIG. 4, until the plug-periphery air-fuel ratio stops exhibiting a change to the rich side, an operation is continued that gradually increases the in-cylinder injection ratio R by an amount corresponding to the fixed amount X each time. The in-cylinder injection ratio R at a time that the plug-periphery air-fuel ratio becomes richest as a result of this operation is regarded as the optimal injection ratio Rb2 under circumstances in which a change over time of pattern 2 is occurring. Further, in a stratified charge combustion operation performed thereafter, this optimal injection ratio Rb2 is used as the in-cylinder injection ratio R in which the influence of the current change over time has been reflected.

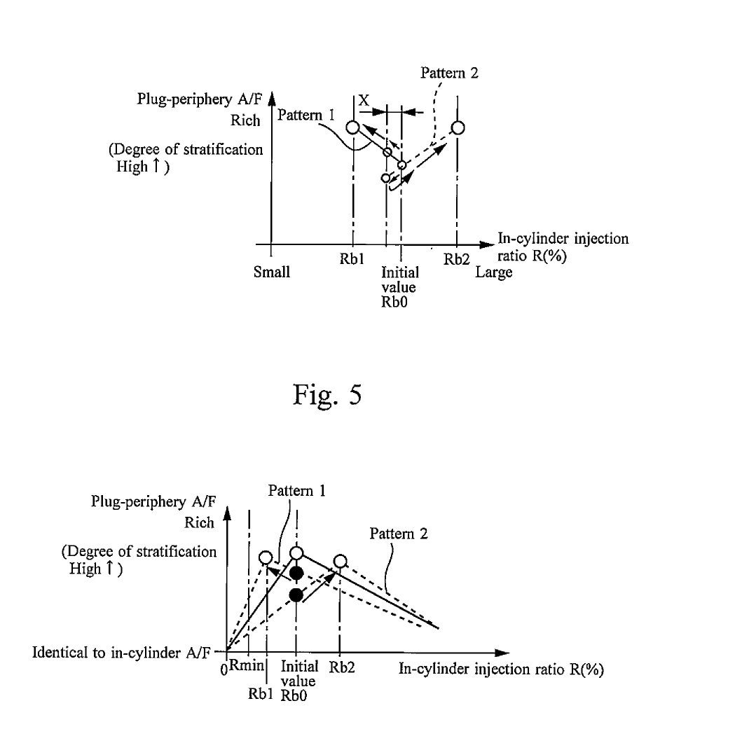

FIG. 5 is a view for describing the effect of the restoration operation for the degree of stratification of the plug-periphery air-fuel mixture that is described above referring to FIG. 4. According to the restoration operation for the degree of stratification that is described above, while distinguishing the pattern of a change over time from among pattern 1 and 2, the optimal injection ratio Rb under the circumstances in which the change over time is occurring is searched for and acquired. That is, as shown in FIG. 5, the in-cylinder injection ratio R is corrected relative to the initial value Rb0 so as to become the optimal injection ratio Rb1 or Rb2 in the current state in which a change over time of pattern 1 or pattern 2 is occurring. By using the optimal injection ratio Rb1 or Rb2 obtained in this manner, an unbalance between the strength of a tumble flow and the spray penetration force that arises due to a change over time is eliminated, and the degree of stratification of the plug-periphery air-fuel mixture can be restored. In addition, by restoring the degree of stratification, an increase in the torque fluctuations and an increase in the NOx discharge amount can be suppressed.

According to the above described technique of the present embodiment, it is possible to efficiently restore the degree of stratification. Specifically, according to the technique of the present embodiment, first, the spray penetration force (in-cylinder injection ratio R) is changed by a predetermined amount (fixed amount X). In accordance with whether the plug-periphery air-fuel ratio becomes richer or leaner accompanying the initial change in the spray penetration force, it is determined whether to increase or decrease the spray penetration force from the second time onwards. This determination of the direction in which to change the spray penetration force from the second time onwards is performed by focusing attention on the existence of pattern 1 or pattern 2 of the change over time. Consequently, according to the present technique, a situation does not arise in which the spray penetration force is changed by a large amount in a manner that does not contribute to improving the degree of stratification. Therefore, according to the present technique, it is possible to efficiently restore the degree of stratification (more specifically, while trial and error relating to changing of the spray penetration force for the purpose of restoring the degree of stratification is suppressed to the minimum).

Further, according to the technique of the present embodiment, a decrease or an increase in the in-cylinder injection ratio R for changing the spray penetration force is continued until the plug-periphery air-fuel ratio stops exhibiting a change to the rich side. By this means, the degree of stratification can be restored so that the degree of stratification becomes highest within a range that can be realized under the state of the current change over time. By this means, the plug-periphery air-fuel ratio can be enriched as much as possible and the stratified charge combustion can be stabilized.

In addition, according to the technique of the present embodiment, the in-cylinder injection ratio R is changed in order to change the spray penetration force. Apart from changing the ratio of the amount of in-cylinder injection that is performed at the specific timing T for stratification in this way, the spray penetration force can also be changed by, for example, changing the fuel injection pressure. However, in the case of using the fuel injection pressure, if the fuel injection pressure is decreased, atomization of the fuel is hindered. As a result, problems of an increase in the amount of fuel adhering to an in-cylinder wall surface and an increase in carbon monoxide (CO) can arise. Further, changing the fuel injection pressure generally requires more time than changing the in-cylinder injection ratio R, with respect to which changing is possible in each cycle. In this regard, according to the present technique the spray penetration force can be changed without such adverse effects. Further, apart from changing the in-cylinder injection ratio R, the plug-periphery air-fuel ratio can also be changed by changing the fuel injection timing. However, because the spray penetration force is not changed by changing the fuel injection timing, the amount of change in the plug-periphery air-fuel ratio is small. In contrast, because the amount of change in the plug-periphery air-fuel ratio generated by a change in the in-cylinder injection ratio R is larger in comparison to the case of changing the fuel injection timing, the plug-periphery air-fuel ratio can be appropriately enriched by restoring the degree of stratification by changing the in-cylinder injection ratio R.

### Specific Processing in First Embodiment

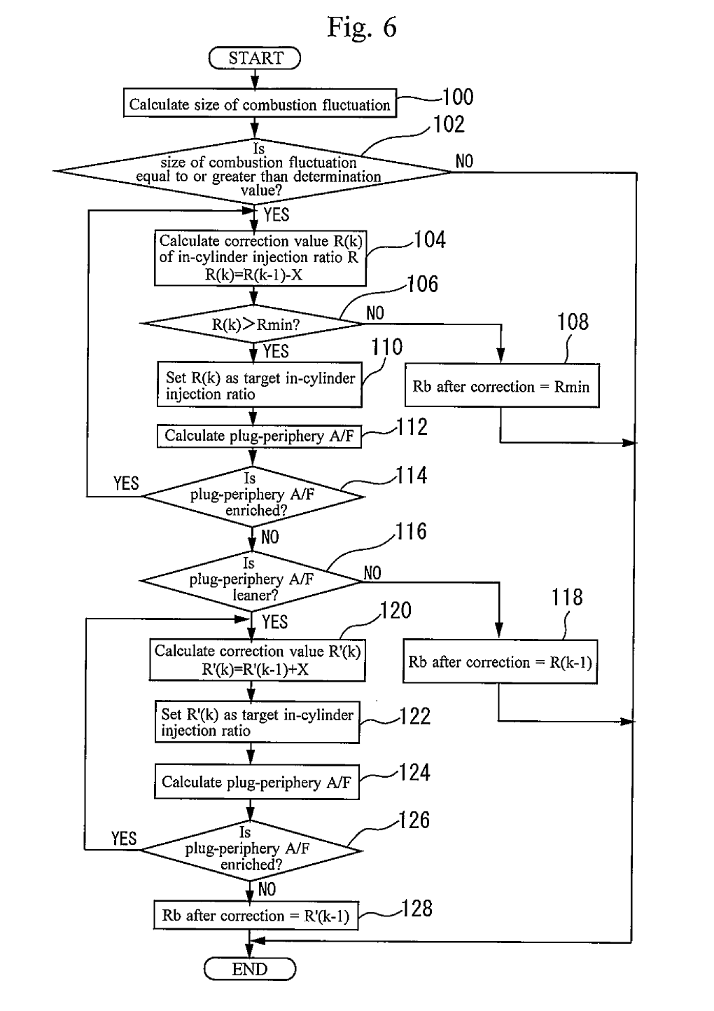

FIG. 6 is a flowchart illustrating the flow of control according to the first embodiment of the present invention. The ECU 40 starts the processing of the present flowchart at a time that fast idle operation starts in association with catalyst warm-up control immediately after the internal combustion engine 10 is cold-started. Note that the processing in this flowchart is executed for each cylinder by the ECU 40.

First, in step 100, the ECU 40 calculates the size of a combustion fluctuation. The size of the combustion fluctuation can be calculated by the following technique. That is, for example, data regarding the in-cylinder pressure detected by the in-cylinder pressure sensor 32 is utilized to calculate an indicated mean effective pressure in each cycle, and a variation in the indicated mean effective pressure in a specified cycle is calculated. This variation may be used as the size of a combustion fluctuation. A configuration may also be adopted in which the crank angle speed is calculated for each cycle utilizing the crank angle sensor 38, and in which a variation in the crank angle speed in a specified cycle is used as the size of a combustion fluctuation.

Next, the ECU 40 proceeds to step 102. In step 102 the ECU 40 determines whether or not the size of a combustion fluctuation is equal to or greater than a predetermined determination value. The determination value is a value that is set in advance as a value with which it can be determined that the degree of stratification of the plug-periphery air-fuel mixture has decreased by an amount that is equal to or greater than a certain level due to a change over time. If the result determined in the present step 102 is negative, the processing of the present flowchart is promptly ended. A case where a decrease in the degree of stratification that is equal to or greater than a certain level that is cause by a change over time is not occurring corresponds to a case where a combustion fluctuation of a size equal to or greater than the determination value is not arising. Further, a case where, even though a change over time is occurring, an appropriate balance between the strength of the tumble flow and the spray penetration force is being maintained as a result of the strength of the tumble flow and the spray penetration force both increasing also corresponds to such a case.

In contrast, a case where a change over time of pattern 1 or pattern 2 is occurring corresponds to a case where a combustion fluctuation of a size equal to or greater than the determination value is arising. In this case, that is, a case where the result of determination in step 102 is affirmative, the ECU 40 proceeds to step 104. In step 104, the ECU 40 calculates a correction value R(k) for the in-cylinder injection ratio R. The correction value R(k) is calculated according to the following equation (1).

R(k)=R(k−1)−X (1)

Where, in equation (1), R(k) is a value that is calculated when correcting the in-cylinder injection ratio R a k^{th} time using the above-described initial value Rb0 (that is, an optimal injection ratio that is adapted in advance) of the in-cylinder injection ratio R as R(0). R(k−1) represents the last value. X represents the above-described fixed amount.

According to the above described equation (1), the correction value (current value) R(k) is calculated as a value that is obtained by subtracting the fixed amount X from the last value R(k−1). In particular, the correction value R(1) that is calculated at the time of the initial (first) correction is obtained by subtracting the fixed amount X from the initial value Rb0 that corresponds to the last value R(0).

Although the fixed amount X is an extremely small amount, it is an amount that is previously determined as a value that can cause a meaningful change in the plug-periphery air-fuel ratio accompanying changing of the in-cylinder injection ratio R. As described hereunder, in order to avoid abrupt changes in the combustion state, changes in the in-cylinder injection ratio R for the purpose of searching for the optimal injection ratio Rb are performed gradually using this kind of fixed amount X.

Next, the ECU 40 proceeds to step 106 to determine whether or not the correction value R(k) calculated in step 104 is greater than the aforementioned minimum injection ratio Rmin. When the result determined in the present step 106 is not affirmative because the correction value R(k) that is calculated this time is equal to or less than the minimum injection ratio Rmin, the ECU 40 proceeds to step 108. In step 108, the minimum injection ratio Rmin is set as the optimal injection ratio Rb in which the current correction by execution of the processing of the flowchart has been reflected.

On the other hand, when it is determined in step 106 that the correction value R(k) is greater than the minimum injection ratio Rmin, the ECU 40 proceeds to step 110. In step 110, the correction value R(k) calculated in step 104 is set as a target in-cylinder injection ratio. By this means, when the specific timing T arrives from the time point of this setting onwards, in-cylinder injection is performed for the purpose of stratification with a fuel injection amount that is in accordance with the correction value R(k).

Next, the ECU 40 proceeds to step 112. In step 112, the processing is performed to calculate the plug-periphery air-fuel ratio in a state in which the in-cylinder injection ratio R is the correction value R(k). As one example of the calculation processing in the present step 112, the calculation is performed by the following procedure. That is, the in-cylinder injection for stratification that is performed with a fuel injection amount in accordance with the correction value R(k) is performed over a predetermined plurality of cycles Y. The plug-periphery air-fuel ratio is calculated in each cycle of the plurality of cycles Y, and the average value of the calculated plug-periphery air-fuel ratios is calculated. The average value calculated in this manner is temporarily stored in a buffer of the ECU 40 so that the average value can be used as a comparison object when further correction of the in-cylinder injection ratio R is performed. According to the above described calculation processing utilizing the average value, the plug-periphery air-fuel ratio in a state in which the correction value R(k) is used can be acquired while reducing the influence of fluctuations in combustion between cycles. However, a method of acquiring the plug-periphery air-fuel ratio in a state in which the correction value R(k) is used is not limited to a method that utilizes an average value as described above, and for example a method may be adopted that uses a value for a single cycle among the plurality of cycles Y. Alternatively, a method may be adopted in which combustion is performed in a state in which the correction value R(k) is used in only a single cycle, not in the plurality of cycles Y, and in which the plug-periphery air-fuel ratio in the cycle is used.

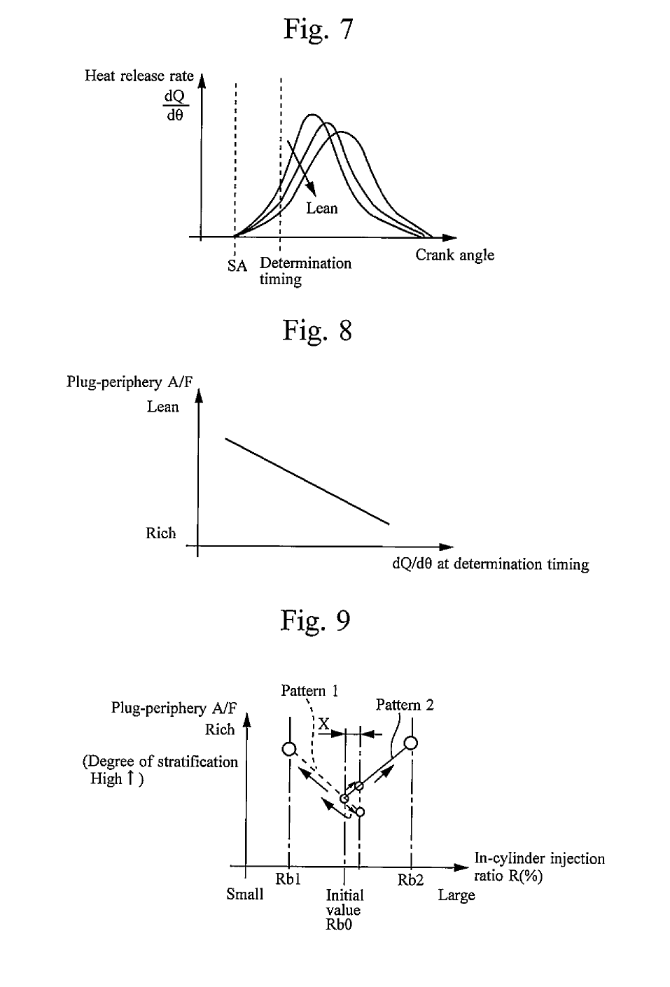

For example, the following technique can be used for calculation of the plug-periphery air-fuel ratio in each cycle. FIG. 7 is a view for describing one example of a technique for calculating the plug-periphery air-fuel ratio, and shows the relation between a heat release rate dQ/dθ and the crank angle. The ECU 40 can acquire data regarding the in-cylinder pressure in synchrony with the crank angle by utilizing the in-cylinder pressure sensor 32 and the crank angle sensor 38. The ECU 40 can use the data regarding the in-cylinder pressure that is acquired in synchrony with the crank angle to calculate data for the heat release rate dQ/dθ in the cylinder in synchrony with the crank angle according to the following equations (2) and (3).

$$\begin{matrix}d Q = d U + d W & ( 2 ) \\ d Q \text{/} d θ = \frac{1}{κ - 1} \times ( V \times \frac{d P}{d θ} + P \times κ \times \frac{d V}{d θ} ) & ( 3 )\end{matrix}$$

Where, equation (2) represents the first law of thermodynamics. In equation (2), U represents internal energy, and W represents work. Further, in equation (3), κ represents the ratio of specific heat, V represents the in-cylinder volume, P represents the in-cylinder pressure, and θ represents the crank angle.

As shown in FIG. 7, the waveform of the heat release rate dQ/dθ changes in accordance with the plug-periphery air-fuel ratio. More specifically, since the combustion becomes slower as the plug-periphery air-fuel ratio becomes leaner, a rise in the heat release rate dQ/dθ becomes slow. Accordingly, by determining the size of the heat release rate dQ/dθ by taking a crank angle that is retarded by a predetermined crank angle period relative to the spark timing (SA) as a predetermined determination timing, the plug-periphery air-fuel ratio can be estimated based on the heat release rate dQ/dθ. More specifically, a favorable crank angle timing as the aforementioned determination timing is a timing at which a rise in the heat release rate dQ/dθ can be determined, and is a timing that is further on the advanced side than a position at which the heat release rate dQ/dθ exhibits a peak value in a case where combustion is performed with the richest plug-periphery air-fuel ratio within a range of fluctuations in the plug-periphery air-fuel ratio that is assumed when the in-cylinder injection ratio R is changed.

FIG. 8 is a view illustrating the relation between the heat release rate dQ/dθ at the determination timing and the plug-periphery air-fuel ratio. A map that is based on the findings described above with reference to FIG. 7 is stored in the ECU 40 for calculating the plug-periphery air-fuel ratio. According to this map, as shown in FIG. 8, the higher that the heat release rate dQ/dθ is at the determination timing, the richer the value that the plug-periphery air-fuel ratio is set to. In step 112, the plug-periphery air-fuel ratio is calculated by referring to such a map.

In an internal combustion engine that includes an in-cylinder pressure sensor, calculation of the heat release rate dQ/dθ is generally performed for each cycle for the purpose of combustion analysis of the respective cycles. As described above with reference to FIG. 7, the influence of the plug-periphery air-fuel ratio in the respective cycles is reflected in the data for the heat release rate dQ/dθ that is calculated for each cycle. Consequently, according to the technique that is described so far with reference to FIG. 7 and FIG. 8, the plug-periphery air-fuel ratio that is utilized in the control of the present embodiment can be easily and accurately estimated by utilizing such kind of heat release rate dQ/dθ.

Next, the ECU 40 proceeds to step 114. In step 114, the ECU 40 determines whether or not the current value A/F(k) that is (the average value of) the plug-periphery air-fuel ratio under combustion using the correction value R(k) has become richer relative to a last value A/F(k−1) that is the plug-periphery air-fuel ratio under the combustion immediately prior to the current correction of the in-cylinder injection ratio R. More specifically, it is determined whether or not a difference obtained by subtracting the current value A/F(k) from the last value A/F(k−1) is equal to or greater than a predetermined value. The predetermined value is a value that is set in advance as a value with which it is possible to determine a change in the plug-periphery air-fuel ratio accompanying a change in the in-cylinder injection ratio R by the fixed amount X. Note that, as the last value A/F(k−1), with regard to correction from the second time onwards, the value that is calculated and stored in the buffer in step 112 is used. With regard to the initial correction, for example, a plug-periphery air-fuel ratio in a plurality of cycles or a single cycle utilized for calculating the size of a combustion fluctuation in step 100 can be calculated and stored in the buffer, and the stored value can be used.

In a case where enrichment of the plug-periphery air-fuel ratio is recognized in step 114, it can be determined that a change over time of pattern 1 is occurring. In this case, the ECU 40 repeats execution of the processing from step 104 onwards. In contrast, when meaningful enrichment concerning the plug-periphery air-fuel ratio is not recognized in step 114, the ECU 40 proceeds to step 116. In step 116, the ECU 40 determines whether or not the current value A/F(k) of the plug-periphery air-fuel ratio has become leaner relative to the last value A/F(k−1). More specifically, the ECU 40 determines whether or not a difference obtained by subtracting the last value (k−1) from the current value A/F(k) is equal to or greater than a predetermined value. The predetermined value is a value that is set based on the similar idea as that for the predetermined value that is used in step 114.

When the result of the determination in step 116 is negative, that is, when, under circumstances in which a change over time of pattern 1 is occurring, neither one of meaningful enriching and meaningful leaning is recognized with respect to the plug-periphery air-fuel ratio regardless of the fact that the in-cylinder injection ratio R is corrected, the ECU 40 proceeds to step 118. In step 118, the in-cylinder injection ratio R prior to the most recent correction, that is, the last value R(k−1), is set as the optimal injection ratio Rb (more specifically, Rb1) in which the current correction by execution of the processing of the flowchart has been reflected.

On the other hand, when leaning of the plug-periphery air-fuel ratio is recognized in step 116, it can be determined that a change over time of pattern 2 is occurring. In this case, the ECU 40 proceeds to step 120. In step 120, a correction value R′(k) of the in-cylinder injection ratio R is calculated. Calculation of the correction value R′(k) is performed using the following equation (4).

R′(k)=R′(k−1)+X (4)

According to the above equation (4), the correction value (current value) R′(k) is calculated as a value that is obtained by adding the fixed amount X to the last value R′(k−1). In particular, the correction value R′(1) that is calculate at the time of the initial (first) correction is obtained by adding the fixed amount X to the initial value Rb0 that corresponds to the last value R′(0).

Next, the ECU 40 proceeds to step 122. In step 122, the correction value R′(k) that is calculated in step 120 is set as the target in-cylinder injection ratio. The ECU 40 then proceeds to step 124. In step 124, performed is processing to calculate the plug-periphery air-fuel ratio in a state in which the in-cylinder injection ratio R is the correction value R′(k). The processing in the present step 124 can be performed similarly to the processing in the above-described step 112.

Next, the ECU 40 proceeds to step 126. In step 126, by similar processing to that in step 114, the ECU 40 determines whether or not the plug-periphery air-fuel ratio has become richer. When it is recognized as a result that the plug-periphery air-fuel ratio has become richer, the ECU 40 repeats execution of the processing from step 120 onwards. On the other hand, when the result determined in step 126 is negative, that is, when, under circumstances in which a change over time of pattern 2 is occurring, the plug-periphery air-fuel ratio stops exhibiting a meaningful change to the rich side regardless of the fact that the in-cylinder injection ratio R has been corrected, the ECU 40 proceeds to step 128. In step 128, the in-cylinder injection ratio R prior to the most recent correction, that is, the last value R′(k−1), is set as the optimal injection ratio Rb (more specifically, Rb2) in which the current correction by execution of the processing of the flowchart has been reflected.

The optimal injection ratio Rb after undergoing correction by the processing according to the flowchart shown in FIG. 6 that is described above is used during fast idle operation that is performed after the processing of the present flowchart ends. In a case where the result of the determination in step 102 is again affirmative during use of the corrected optimal injection ratio Rb, a further correction of the optimal injection ratio Rb is attempted by means of the processing according to the present flowchart.

Note that, in the above-described first embodiment, the ECU 40 that executes the processing according to the flowchart illustrated in FIG. 6 corresponds to “control device” according to the present application, and changing the in-cylinder injection ratio R a first time for the purpose of changing the spray penetration force corresponds to “performing one operation a first time” according to the present application. Further, the aforementioned determination timing at which the size of the heat release rate dQ/dθ is determined corresponds to “predetermined crank angle timing” according to the present application.

### Second Embodiment

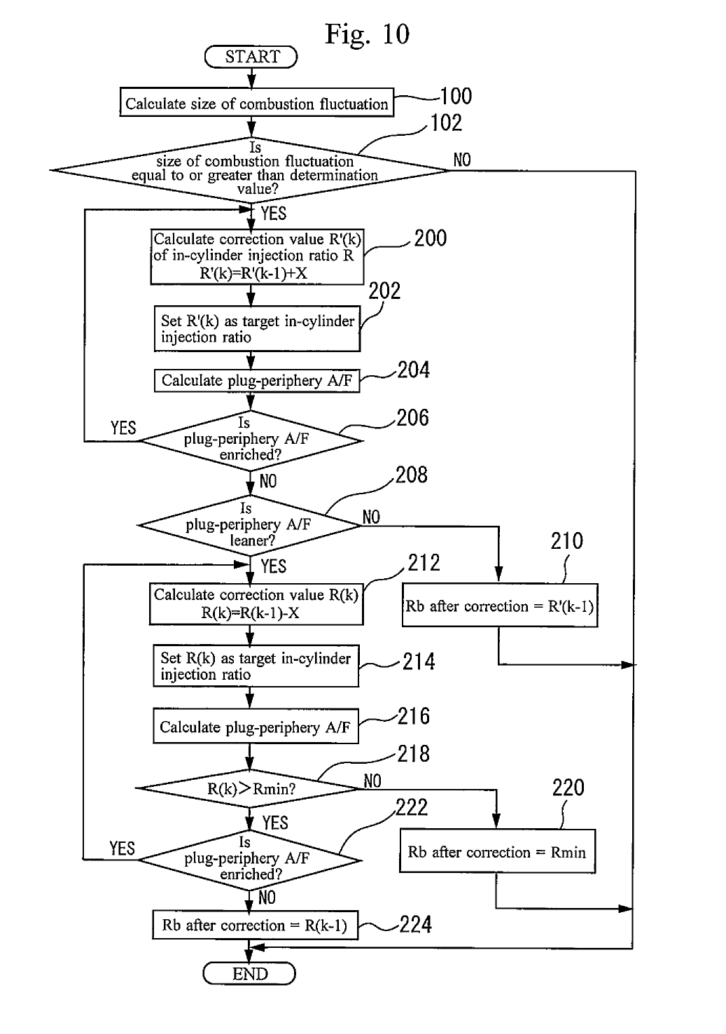

Next, a second embodiment of the present invention will be described with reference mainly to FIG. 9 and FIG. 10.

### Control of Second Embodiment

### Characteristic Operation of Second Embodiment

The present embodiment is similar to the foregoing first embodiment with regard to the fundamental part thereof that, in order to efficiently restore the degree of stratification in a case where a change over time occurs, an operation is performed to search for the optimal injection ratio Rb of the in-cylinder injection ratio R that is accompanied by processing to determine which of pattern 1 and 2 the pattern of the change over time is. However, the operations according to the present embodiment differ from the operations according to the first embodiment with respect to a point that is described hereunder referring to FIG. 9.

FIG. 9 is a view for describing a characteristic restoration operation to restore the degree of stratification of a plug-periphery air-fuel mixture according to the second embodiment of the present invention, which is performed in a case where a change over time occurs in the internal combustion engine 10. In the above-described first embodiment a configuration is adopted in which an initial change of the in-cylinder injection ratio R for the purpose of changing the spray penetration force is performed by lowering the in-cylinder injection ratio R on a trial basis by only a predetermined fixed amount X. In contrast, in the present embodiment, as shown in FIG. 9, initial changing of the in-cylinder injection ratio R is performed by raising the in-cylinder injection ratio R on a trial basis by only the predetermined fixed amount X.

In a case where the pattern of a change over time that is occurring is pattern 2, if the spray penetration force is increased by the above-described changing of the in-cylinder injection ratio R, the balance between the strength of the tumble flow and the spray penetration force will improve. As a result, the degree of stratification will be higher and the plug-periphery air-fuel ratio will become richer. Consequently, in a case where the plug-periphery air-fuel ratio becomes richer as a result of raising the in-cylinder injection ratio R the first time by the fixed amount X, it can be determined that the pattern of the current change over time is the pattern 2. If the circumstances are those under which a change over time of pattern 2 is occurring, during a period until the in-cylinder injection ratio R becomes the optimal injection ratio Rb2 under these circumstances, the plug-periphery air-fuel ratio will become richer by raising the in-cylinder injection ratio R.

Therefore, in this case, as shown by a solid line in FIG. 9, an operation to gradually raise the in-cylinder injection ratio R by an amount corresponding to the fixed amount X each time is continued until the plug-periphery air-fuel ratio stops exhibiting a change to the rich side. The in-cylinder injection ratio R at the time that the plug-periphery air-fuel ratio becomes richest as a result of this operation is regarded as the optimal injection ratio Rb2 under circumstances in which a change over time of pattern 2 is occurring. Further, in a stratified charge combustion operation performed thereafter, this optimal injection ratio Rb2 is used as the in-cylinder injection ratio R in which the influence of the current change over time has been reflected.

On the other hand, in a case where the pattern of a change over time that is occurring is pattern 1, if the spray penetration force is increased by the above-described changing of the in-cylinder injection ratio R, the balance between the strength of the tumble flow and the spray penetration force will deteriorate. As a result, the degree of stratification will decrease and the plug-periphery air-fuel ratio will become leaner. Consequently, in a case where the plug-periphery air-fuel ratio becomes leaner as a result of raising the in-cylinder injection ratio R the first time by the fixed amount X, it can be determined that the pattern of the current change over time is the pattern 1. If the operation to raise the in-cylinder injection ratio R is continued regardless of the fact that the operation is performed under such circumstances, the degree of stratification will decrease further, and the plug-periphery air-fuel ratio will become leaner.

Therefore, in this case, as shown by the broken line in FIG. 9, changing of the in-cylinder injection ratio R that is performed the second time is performed in an opposite direction to the operation that is performed the first time (that is, a direction that decreases the in-cylinder injection ratio R). The amount by which the in-cylinder injection ratio R is changed in this case is, as one example, the fixed amount X. During a period until the in-cylinder injection ratio R becomes the optimal injection ratio Rb1 under circumstances in which the change over time of pattern 1 is occurring, the plug-periphery air-fuel ratio becomes richer as a result of lowering the in-cylinder injection ratio R. Consequently, in this case, as illustrated by the broken line in FIG. 9, until the plug-periphery air-fuel ratio stops exhibiting a change to the rich side, an operation is continued that gradually lowers the in-cylinder injection ratio R by an amount corresponding to the fixed amount X each time. The in-cylinder injection ratio R at the time that the plug-periphery air-fuel ratio becomes richest as a result of this operation is regarded as the optimal injection ratio Rb1 under circumstances in which a change over time of pattern 1 is occurring. Further, in a stratified charge combustion operation performed thereafter, this optimal injection ratio Rb1 is used as the in-cylinder injection ratio R in which the influence of the current change over time has been reflected. Note that, in a case where the in-cylinder injection ratio R arrives at the minimum injection ratio Rmin during the course of the operation to change the in-cylinder injection ratio R, the minimum injection ratio Rmin is used as the in-cylinder injection ratio R in which the influence of the current change over time has been reflected.

By means of the above-described operation to restore the degree of stratification of the present embodiment also, the optimal injection ratio Rb under circumstances in which a change over time is occurring is searched for and acquired while determining the pattern of the change over time from among patterns 1 and 2. Further, by means of the technique of the present embodiment also, it is possible to efficiently restore the degree of stratification (more specifically, while trial and error relating to changing of the spray penetration force for the purpose of restoring the degree of stratification is suppressed to the minimum).

### Specific Processing in Second Embodiment

FIG. 10 is a flowchart illustrating the flow of control according to the second embodiment of the present invention. Note that, in FIG. 10, steps that are the same as steps shown in FIG. 6 in the first embodiment are denoted by the same reference numerals, and a description of those steps is omitted or simplified. Further, in the following description relating to the processing of the present flowchart, differences from the processing of the flowchart shown in FIG. 6 are mainly described.

When the ECU 40 determines in step 102 that a combustion fluctuation of a size equal to or greater than the determination value is arising, the ECU 40 proceeds to step 200. In step 200, the ECU 40 calculates the correction value R′(k) in accordance with equation (4) by similar processing to that in the above-described step 120. Next, in step 202, the correction value R′(k) that is calculated in step 200 is set as the target in-cylinder injection ratio. Next, in step 204, performed is processing to calculate the plug-periphery air-fuel ratio in a state in which the in-cylinder injection ratio R is the correction value R′(k).

Next, in step 206, the ECU 40 determines whether or not the plug-periphery air-fuel ratio calculated in step 204 has become richer. When it is recognized as a result that the plug-periphery air-fuel ratio has become richer, it can be determined that a change over time of pattern 2 is occurring. In this case, the ECU 40 repeats execution of the processing from step 200 onwards. In contrast, when in step 206 meaningful enrichment is not recognized with respect to the plug-periphery air-fuel ratio, the ECU 40 proceeds to step 208. In step 208, the ECU 40 determines whether or not the plug-periphery air-fuel ratio has been made leaner.

When the result of the determination in step 208 is negative, that is, when, under circumstances in which a change over time of pattern 2 is occurring, neither one of meaningful enriching and meaningful leaning is recognized with respect to the plug-periphery air-fuel ratio regardless of the fact that the in-cylinder injection ratio R is corrected, the ECU 40 proceeds to step 210. In step 210, the in-cylinder injection ratio R prior to the most recent correction, that is, the last value R′(k−1), is set as the optimal injection ratio Rb (more specifically, Rb2) in which the current correction by execution of the processing of the flowchart has been reflected.

On the other hand, when leaning of the plug-periphery air-fuel ratio is recognized in step 208, it can be determined that a change over time of pattern 1 is occurring. In this case, the ECU 40 proceeds to step 212. In step 212, the correction value R(k) is calculated in accordance with equation (1) by similar processing as in the above-described step 104. Next, in step 214, the correction value R(k) that is calculated in step 212 is set as the target in-cylinder injection ratio. Thereafter, in step 216, performed is processing to calculate the plug-periphery air-fuel ratio in a state in which the in-cylinder injection ratio R is the correction value R(k).

Next, the ECU 40 proceeds to step 218. When it is determined in step 218 that the present correction value R(k) is equal to or less than the minimum injection ratio Rmin, the ECU 40 proceeds to step 220. In step 220, the minimum injection ratio Rmin is set as the optimal injection ratio Rb in which the current correction by execution of the processing of the flowchart has been reflected.

In contrast, when it is determined in step 218 that the correction value R(k) is greater than the minimum injection ratio Rmin, the ECU 40 proceeds to step 222. When it is recognized in step 222 that the plug-periphery air-fuel ratio calculated in step 216 has become richer, the ECU 40 repeats execution of the processing from step 212 onwards. On the other hand, when the result determined in step 222 is negative, that is, when, under circumstances in which a change over time of pattern 1 is occurring, the plug-periphery air-fuel ratio stops exhibiting a meaningful change to the rich side regardless of the fact that the in-cylinder injection ratio R has been corrected, the ECU 40 proceeds to step 224. In step 224, the in-cylinder injection ratio R prior to the most recent correction, that is, the last value R(k−1), is set as the optimal injection ratio Rb (more specifically, Rb1) in which the current correction by execution of the processing of the flowchart has been reflected.

Note that, in the above described second embodiment, the ECU 40 that executes the processing according to the flowchart illustrated in FIG. 10 corresponds to “control device” according to the present application.

### Other Embodiments

The foregoing first and second embodiments have been described taking as an example a technique that estimates the plug-periphery air-fuel ratio using the heat release rate dQ/dθ that is calculated utilizing the in-cylinder pressure sensor 32. However, a technique for acquiring the plug-periphery air-fuel ratio according to the present application is not limited to the technique described above, and may be the following kind of technique. That is, an optical sensor is known that is integrated with a spark plug and is capable of detecting a fuel concentration by utilizing an infrared absorption method. For example, the plug-periphery air-fuel ratio may also be a ratio that is detected utilizing the aforementioned optical sensor. Further, an optical sensor that detects light emission of a radical in combustion gas is known. The plug-periphery air-fuel ratio may also be, for example, a ratio that is estimated based on the light emission intensity of a predetermined radical that is calculated utilizing the output of such kind of optical sensor.

In the above-described first and second embodiments, a configuration is adopted in which whether the spray penetration force (in-cylinder injection ratio R) should be decreased or increased is determined depending on the plug-periphery air-fuel ratio that is calculated based on the size of the heat release rate dQ/dθ at the determination timing. However, a parameter that is used when changing the spray penetration force in the present application is not necessarily limited to a parameter that is acquired as the plug-periphery air-fuel ratio, as long as the parameter is an air-fuel ratio index value that has a correlation with the plug-periphery air-fuel ratio. That is, an air-fuel ratio index value of the present application may be a value that, for example, shows the size of a combustion fluctuation. Although combustion fluctuations deteriorate under an excessively rich combustion air-fuel ratio, it can be said that, within the range of fluctuations in the plug-periphery air-fuel ratio that are assumed at a time of stratified charge combustion operation using the air guide method, the combustion fluctuations decrease as the air-fuel ratio becomes richer. Accordingly, in a case of using, as the aforementioned air-fuel ratio index value, a value that shows a size of a combustion fluctuation, when the spray penetration force is changed and the combustion fluctuation decreases, the air-fuel ratio index value can be regarded as exhibiting a change to the rich side, and conversely, when the combustion fluctuation increases, the air-fuel ratio index value can be regarded as exhibiting a change to the lean side.

Further, in the above-described first and second embodiments, a configuration is adopted which changes the in-cylinder injection ratio R (fuel injection ratio) in order to change the spray penetration force. However, the spray penetration force in the present application may be changed by changing a parameter associated with combustion that is other than the fuel injection ratio (for example, by changing the fuel injection pressure). However, as described in the foregoing, it can be said that a technique that changes the fuel injection ratio is a superior technique from the viewpoint of, for example, atomization of fuel.

The foregoing first and second embodiments have been described taking as an example a technique that uses the in-cylinder injection valve 28 and the port injection valve 26 for fuel injection when performing stratified charge combustion. However, an internal combustion engine that is an object of the present application may be an internal combustion engine which includes only the in-cylinder injection valve, and in which the port injection valve is not provided. Further, the fuel injection that is performed when performing stratified charge combustion in such an internal combustion engine may be divided injection which uses only the in-cylinder injection valve and which divides, into a plurality of fuel injection operations, a fuel injection operation for injecting a fuel injection amount that should be injected during a single cycle. More specifically, the first fuel injection that is the main fuel injection may be performed in the intake stroke, and fuel injection of a small amount that is necessary for stratification may be performed at the specific timing T that is described above referring to FIG. 1.

Further, in the above-described first and second embodiments, a configuration is adopted which, at the time of fast idle operation that utilizes stratified charge combustion, changes the in-cylinder injection ratio R to thereby change the spray penetration force in order to restore the degree of stratification of the plug-periphery air-fuel mixture. However, a time of performing stratified charge combustion operation that is an object for changing the spray penetration force in the present application is not limited to a time of fast idle operation, and, for example, may be a time at which lean-burn operation is performed utilizing stratified charge combustion in a predetermined operating range.

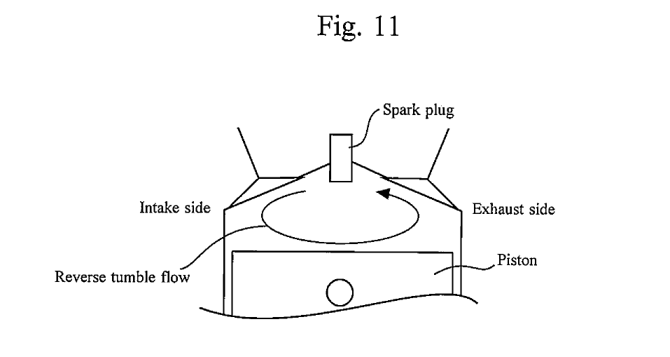

Furthermore, the foregoing first and second embodiments have been described taking a forward tumble flow that ascends on the intake side and descends on the exhaust side as an example of a tumble flow that is generated inside the combustion chamber 14. However, a tumble flow to which the present application can be applied is not limited thereto. FIG. 11 is a view that illustrates the manner in which a reverse tumble flow that descends on the intake side and ascends on the exhaust side is generated inside the combustion chamber 14. The present application can also be applied to an internal combustion engine in which a reverse tumble flow is generated inside a cylinder as shown in FIG. 11.

1. An internal combustion engine in which a tumble flow is generated inside a combustion chamber, comprising:
a spark plug arranged at a central part of a wall surface of the combustion chamber on a cylinder head side;
an in-cylinder injection valve configured to inject fuel at a specific timing so that, when stratified charge combustion operation is performed, a fuel spray proceeds towards a vortex center of the tumble flow; and
a control device configured to calculate a size of a combustion fluctuation during stratified charge combustion operation, and in a case where the size of the combustion fluctuation that is calculated is greater than a determination value, change a spray penetration force of fuel injection that is performed at the specific timing so that a plug-periphery air-fuel ratio that is an air-fuel ratio of an air-fuel mixture at a periphery of the spark plug at an spark timing changes to a rich side,
wherein the control device is configured to calculate an air-fuel ratio index value that has a correlation with the plug-periphery air-fuel ratio, and
wherein changing of the spray penetration force by the control device is performed by performing any one operation among an operation that increases the spray penetration force and an operation that decreases the spray penetration force, and in a case where the air-fuel ratio index value exhibits a change to a rich side as a result of performing the one operation a first time, the one operation is continued, while in a case where the air-fuel ratio index value exhibits a change to a lean side as a result of performing the one operation the first time, the other operation among the operation that increases the spray penetration force and the operation that decreases the spray penetration force is performed.

2. The internal combustion engine according to claim 1,
wherein the control device continues performance of the one operation or the other operation until the air-fuel ratio index value stops exhibiting a change to the rich side.

3. The internal combustion engine according to claim 1,
wherein the internal combustion engine performs, during a single cycle, fuel injection a plurality of times including fuel injection at the specific timing, and
wherein the changing of the spray penetration force by the control device is performed by changing a fuel injection ratio that is a ratio of an amount of fuel injected by the fuel injection at the specific timing with respect to a total amount of fuel injected by the fuel injection that is performed the plurality of times.

4. The internal combustion engine according to claim 3, further comprising a port injection valve configured to inject fuel into an intake port,
wherein the total fuel injection amount is a total value of fuel injection amounts by fuel injection that is performed the plurality of times using the in-cylinder injection valve and the port injection valve during a single cycle.

5. The internal combustion engine according to claim 1, further comprising an in-cylinder pressure sensor that detects an in-cylinder pressure,
wherein the control device calculates a heat release rate inside a cylinder based on an in-cylinder pressure that is detected by the in-cylinder pressure sensor, and
wherein the air-fuel ratio index value is a size of a heat release rate inside the cylinder at a predetermined crank angle timing.
